(19) United States
(12) Patent Application Publication
(10) Pub. No.: US 2003/0115288 A1
(43) Pub. Date: Jun. 19, 2003

(54) Technique for effective management of information and communications using a mobile device

(76) Inventors: Philip A. Ljubicich, Lake Forest Park, WA (US); Pankaj Kumar, Seattle, WA (US)

Correspondence Address: Alex L. Yip, Laye Scholer LLP, 425 Park Avenue, New York, NY, 10022, US

(21) Appl. No.: 10/017,030

(22) Filed: Dec. 14, 2001

(51) Int. Cl. G06F 15/16

(52) U.S. Cl. 709/219

(57) ABSTRACT

A user of a mobile device, e.g., a WAP enabled wireless telephone, may call an information service for assistance, e.g., requesting desired telephone numbers, event schedules, movie listings, restaurant recommendations, etc. In accordance with the invention, the requested information is organized and maintained for the user in a data location, e.g., a WAP site, which can be accessed by the user using the mobile device at the user's convenience. For example, after accessing the previously requested listings on the WAP site, the user may utilize the mobile device to initiate calls to selected telephone numbers, make reservation for selected events, or obtain directions to selected venues in such listings. In accordance with an aspect of the invention, when a call is connected through the information service, the user is afforded a first set of options displayed on the mobile device for selection after the call is successfully completed. Otherwise, if the call cannot be successfully completed, the user is afforded a second set of displayed options to obtain further assistance from the information service.

### FIELD OF THE INVENTION

The invention relates to a communications technique, and more particularly to a technique using a mobile device, e.g., a wireless telephone, for communications based on information provided by the mobile device.

### BACKGROUND OF THE INVENTION

Nowadays, use of mobile devices, e.g., wireless telephones, personal digital assistants (PDAs), etc., to access and communicate information via a wireless network is ubiquitous. However, to enable mobile devices to effectively access the Internet through the wireless network, which is not an ideal network for such access as it typically affords low bandwidth, high latency and unreliable connections, wireless application protocol (WAP) and Java 2 platform, micro edition (J2ME) standards for mobile devices have been developed to overcome the particular constraints of the wireless environment.

For example, similar to the Internet standards, WAP specifies use of a wireless markup language (WML) for writing WAP content. WML is designed to make optimum use of a small display which is typical of a mobile device. The resulting WAP content is scalable, e.g., from a two-line text display to a full graphic screen of a larger display. The WAP content can be read by a user using WAP microbrowser software installed in the mobile device. The communications between the mobile device and the Internet is through a WAP gateway, which serves as an interface between a wireless network and the Internet.

The WAP gateway provides the necessary protocol translation (e.g., between WAP and transmission control protocol/Internet protocol (TCP/IP)) and optimization, security, activity tracking and administration. Messages communicated between a mobile device and the WAP gateway are in accordance with a WAP datagram protocol (WDP). For example, when a request from the mobile device which comprises a uniform resource locator (URL) is sent via a wireless network to the WAP gateway, the request includes a device identification (ID) identifying the mobile device. In response, a hypertext transfer protocol (HTTP) interface in the gateway retrieves the requested content from the WAP site on the Internet at the URL. The retrieved content is converted into a compressed data format for transmission over the wireless network to the mobile device identified by its device ID. The WAP microbrowser software in the mobile device interprets the compressed data and displays the interactive WAP content.

It is well known that a wireless network can support both data and voice services. Well known mobile data services include, e.g., a short message service (SMS), unstructured supplementary services data (USSD), circuit-switched cellular data (CSD), cellular digital packet data (CDPD), general packet radio service (GPRS), etc. Well known mobile voice services include advanced mobile phone system (AMPS), global system for mobile communication (GSM), personal communications service (PCS), etc. However, to unify these disparate mobile data and voice standards, an idea of a third generation (3G) mobile phone system emerged. Instead of different network types being adopted, the plan is for a single 3G network standard to be implemented, which supports, among others, simultaneous data and voice communications with an end user. Although the ultimate 3G network is in the works, it is believed that the building blocks therefor, e.g., the 3G network node, base station, mobile switching center (MSC), radio network controller (RNC), media gateway (MGW), etc., are in place and/or well defined. In fact, the industry is confident that certain 3G mobile phone services are to be deployed in the very near future. For example, the 3G backbone network may be built as a mesh of IP routing or asynchronous transfer mode (ATM) switching nodes interconnected by point to point links. In particular, an IP over ATM architecture may be employed which uses ATM switching to multiplex IP traffic. This IP over ATM architecture supports voice traffic alongside IP.

In addition, it is a common experience to use, e.g., a wireless or wireline telephone, to call an operator for information assistance. In a typical information assistance call, a caller identifies to the operator the name and address of a party whose telephone number is desired. In response, the operator locates the desired destination number using, e.g., a computer database. The destination number is then provided to the caller, e.g., by a computerized voice server which provides automated voicing of the number.

### SUMMARY OF THE INVENTION

We have recognized certain disadvantages associated with the prior art information assistance service. For example, the information provided by the prior art service to a user is on a call-by-call basis. That is, the prior art service fails to provide a user with access to the information previously requested by the user from earlier information assistance calls. In addition, if the user wants to record the information for future use which is provided verbally by the prior art service, the user needs to record it by hand. This proves to be, at best, inconvenient for mobile device users, especially for those who are driving.

However, the invention overcomes the prior art limitations by having an information provider organize and store the information previously requested by a user at a data location (e.g., a WAP site or a website), which is accessible using a mobile device (e.g., a WAP enabled mobile device) at the user's convenience. Thus, in accordance with the invention, after an information provider receives from a user a request through a first medium, e.g., a voice medium, the provider searches a database for information responsive to the request. The responsive information is organized at the aforementioned data location so that the user can later retrieve therefrom desired information through a second medium, e.g., a data medium. In accordance with an aspect of the invention, selected, retrieved information may be enclosed in a message, e.g., a token, generated by the mobile device for transmission to the information provider. Based on the content of the message, the provider provides such services as making reservation for the user, supplying directions to a given address, etc.

In accordance with another aspect of the invention, after a voice connection with a mobile device is initiated, the status condition of the voice connection is identified. Using an advanced wireless facility, e.g., 3G wireless network, the mobile device may be provided with data in response to the identified status condition through a data connection.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1 illustrates an information system in accordance with the invention;

FIG. 2 illustrates a WAP enabled wireless telephone which may be used to communicate with the system of FIG. 1;

FIG. 3 illustrates the schematics of the telephone of FIG. 2;

FIG. 4 illustrates an arrangement in which the WAP enabled wireless telephone is used to access data from the Internet;

FIGS. 5 through 12 illustrate various WAP pages received by, and shown on a screen of, the WAP enabled wireless telephone;

FIG. 13 is a flow chart depicting a process for delivering a WAP page by a WAP server in accordance with the invention;

FIG. 14 illustrates a first information assistance menu presented to the WAP enabled wireless telephone after a call is successfully completed; and

FIG. 15 illustrates a second information assistance menu presented to the WAP enabled wireless telephone when a call cannot be successfully completed.

### DETAILED DESCRIPTION

The invention is directed to a technique for effectively providing, to a mobile device user, information previously requested by the user from an information provider. In prior art, a user may utilize a mobile device, e.g., a wireless telephone, to call an operator for information assistance. In a typical information assistance call, a caller identifies to the operator the name and address (or sometimes city or area code) of a party whose telephone number is desired. In response, the operator locates the desired destination number using, e.g., a computer database. The destination number is then provided to the caller, e.g., by a computerized voice server which provides automated voicing of the number. In addition to the directory information, other information such as restaurant recommendations, movie listings, directions to a given destination, event information, etc. may also be obtained from the information assistance call.

We have recognized certain disadvantages associated with the prior art information assistance service. For example, the information provided by the prior art service to a user is on a call-by-call basis. That is, the prior art service fails to provide a user with access to the information previously requested by the user from earlier information assistance calls. In addition, if the user wants to record the information for future use which is provided verbally by the prior art service, the user needs to record it by hand. This proves to be, at best, inconvenient for mobile device users, especially for those who are driving.

However, the invention overcomes the prior art limitations by having an information provider organize and store the information previously requested by a user at a data location (e.g., a WAP site or website) accessible using a mobile device at the user's convenience. In addition, based on user configuration data, the information provider customizes the presentation of the information on the WAP site to facilitate the user's access to the information and communications using the mobile device.

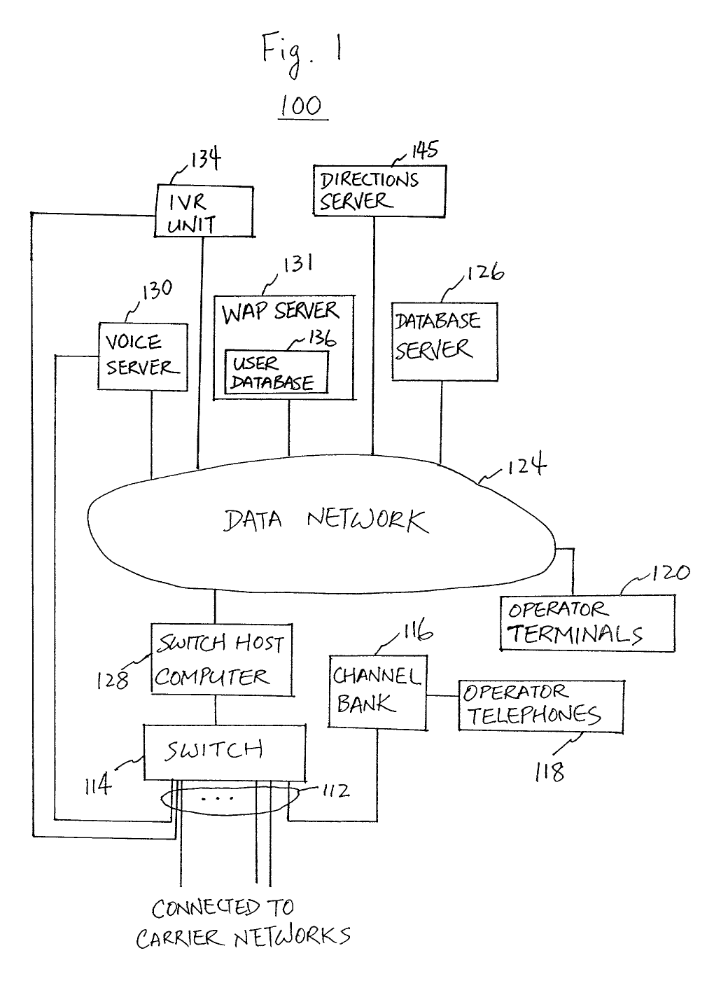

FIG. 1 illustrates information system 100 for providing an information assistance service to a user in accordance with the invention. In this illustrative embodiment, the user utilizes a mobile device, e.g., a WAP enabled wireless telephone, to call an information assistance operator in system 100 to request information such as directory information, restaurant recommendations, movie listings, directions to a given destination, event information, etc. The term “operator” used herein broadly encompasses entities that are capable of providing information assistance in a communication environment, including without limitation human operators, voice response/recognition capabilities, web- or WAP-enabled operator services, and other electronic access. The operator obtains the requested information and provides it to the user. However, in accordance with the invention, the operator also causes the requested information to be organized and stored on a WAP site at a predetermined URL accessible by the user for his/her future reference.

As shown in FIG. 1, information system 100 includes switch 114 having T1 spans 112 for connection to voice server 130, channel bank 116 and carrier networks. Channel bank 116 is used to couple multiple operator telephones 118 to switch 114. The operators in system 100 are further equipped with operator terminals 120, each of which includes a video display unit and a keyboard with associated dialing pad. Operator terminals 120 are connected over data network 124 to one or more database server(s) 126 (although only one is shown here). Switch host computer 128, voice server 130, WAP server 131, interactive voice response (IVR) unit 134, and directions server 145 are also connected to data network 124. By way of example, data network 124 includes a local area network (LAN) supplemented by a number of point-to-point data links. Through data network 124 and routers (not shown), components of system 100, e.g., WAP server 131, are connected to the Internet.

System 100 may receive an incoming information assistance call from one of the carrier networks through a carrier switching center therein. It also places outgoing calls through one of the carrier networks which may be different than that used for the incoming call.

Switch 114 is conventional and supports digital T1 connectivity. The operation of switch 114 is governed by instructions stored in switch host computer 128. In this illustrative embodiment, switch 114 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on system 100 and switch 114 for each corresponding function.

Each incoming information assistance call from a user is received by switch 114 in system 100 which connects it to an available operator's telephone. If no operator is available when a call is received, the call is queued in a conventional manner until an operator becomes available. The queuing and call distribution in this instance is in accordance with a standard automatic call distribution (ACD) algorithm. Operators may utilize database server 126 to provide information assistance including searching for a user's desired party and determining the appropriate destination number of the party. Other information assistance concerning restaurant recommendations, movie listings, events, etc. may also be provided by searching database server 126.

A daemon process runs on directions server 145. As is conventional, the daemon process is an agent program which continuously operates on server 145 as a background process and performs system-wide functions. In this instance, these functions include communicating with a remote map server on the Internet at a predetermined URL. This map server is capable of providing maps and directions from a given origination point to a given destination point. For example, instructed by the daemon process, directions server 145 elicits from an operator information, e.g., on the origination and destination addresses provided by the user for which the directions are sought. Directions server 145 then arranges the provided information in an appropriate format for transmission to the map server via the Internet. After learning the origination and destination addresses, the map server returns the requested directions from the origination address to the destination address. The directions are then provided to the user, e.g., via IVR unit 134 and/or at a data location, e.g., a WAP site, through WAP server 131. It should be noted that the map server is also capable of providing directions based on geocoded origination and destination addresses, e.g., in GPS, longitude and latitude coordinates, etc.

Voice server 130 is used to play the constant repeated parts of an operator's speech, namely, the various greetings and signoffs (or closings). Server 130 is connected via data network 124 to switch host computer 128 and via one or more T1 spans to switch 114. Voice server 130 may comprise a general purpose computer and one or more voice cards for voice recognition, voice recording and playback, and call progress analysis. At appropriate stages in a call progression, switch host computer 128 initiates a voice path connection between VRU 130 and switch 114 such that the user, or the user and the operator, are able to hear whatever pre-recorded speech is played on that connection by VRU 130. Computer 128 then instructs VRU 130, via data network 124, what type of message to play, and passes data parameters that enable VRU 130 to locate the message appropriate to the call state.

For example, an information assistance call is received by system 100 via an inbound channel of one of T1 spans 112 at switch 114. The information assistance call may originate at virtually any communication device capable of communications with system 100, e.g., a wireless telephone, wireline telephone, personal digital assistant (PDA), mobile communications device, etc. In receiving the call, system 100 also receives call set-up signals containing data such as the caller's automatic number identification (ANI), and the area of the call's origination, e.g., the originating cell site.

Let's assume in this instance that the user previously made a number of information assistance calls requesting information from system 100. For each call, the operator responding to the call causes WAP server 131 to incorporate the requested information into a user file which is stored in user database 136 in association with a user telephone number, and contains earlier requested information. Specifically, the newly requested information is associated with the telephone number of the user derived from the ANI in the call set-up signals. Based on the user telephone number, the newly requested information is incorporated into the user file stored in association with the user telephone number. Utilizing the WAP enabled wireless telephone, the user may access the user file on WAP server 131 at a predetermined WAP site or URL. The WAP enabled wireless telephone includes therein a well known microbrowser for browsing data in the user file expressed in WML, including those concerning previous information assistance transactions. In addition, WAP server 131 allows access to the data in a user-friendly format and allows for optimization in searching the data based on past user interactions with the WAP site.

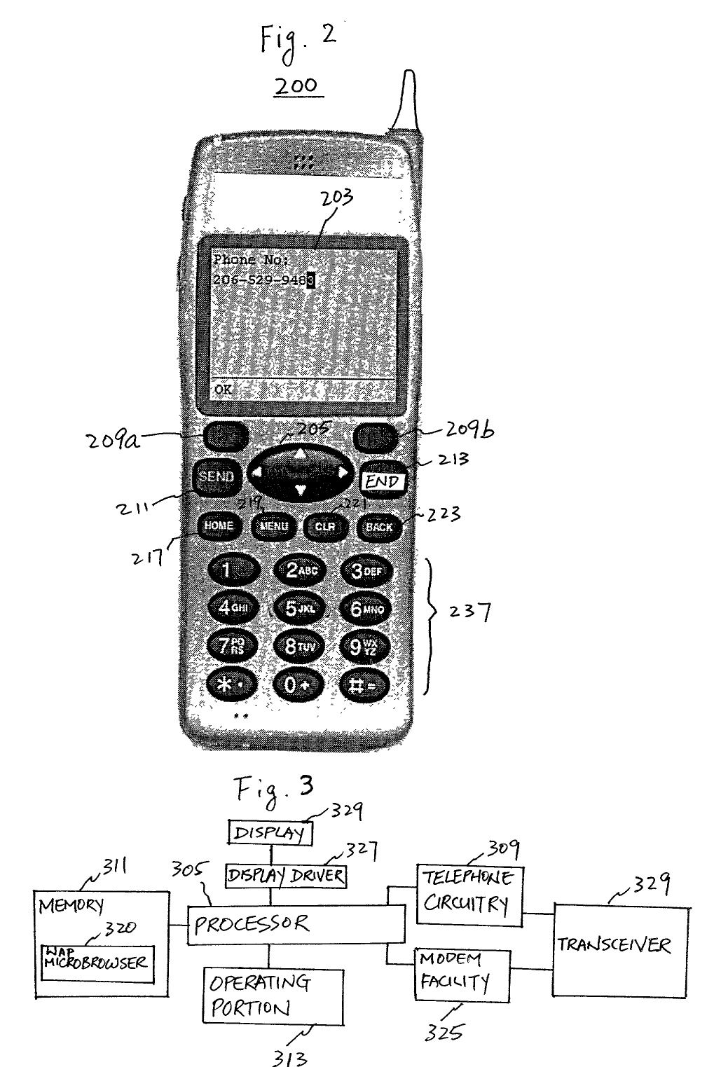

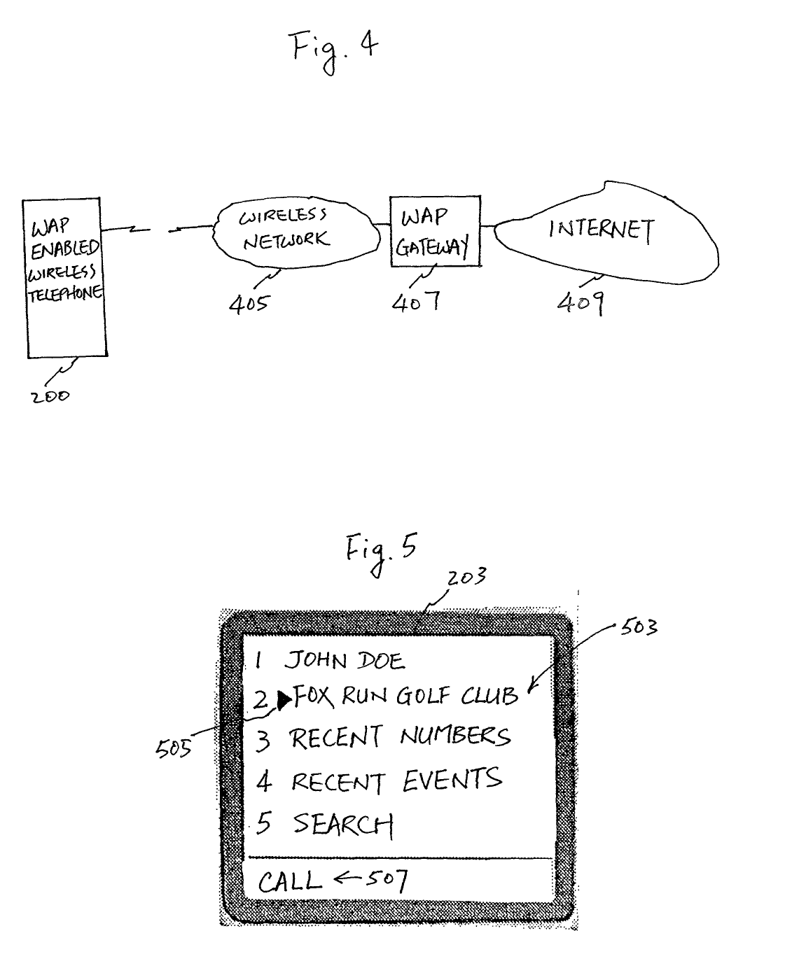

FIG. 2 illustrates WAP enabled wireless telephone 200 which may be used for accessing the predetermined WAP site. As shown in FIG. 2, telephone 200 includes, among others, display screen 203 for displaying information, e.g., WAP content; navigation key 205 for navigating through different options displayed on the screen; and action keys 209a and 209b for selecting the functions or actions displayed on screen 203 immediately above the respective keys. The displayed actions associated with keys 209a and 209b are configurable based on specific WAP applications and may vary in assignment based on context. For example, an action key becomes an “enter” key when the displayed action says “OK”. In addition, SEND key 211 is used for initiating a phone call after a calling number is input using key pad 237. Conversely, end key 213 is used for terminating a phone call. HOME key 217 is used for accessing a designated initial screen on screen 203. MENU key 219 is used for accessing a browser menu including multiple options, one of which is bookmarks option containing suboptions for accessing bookmarked WAP sites. In this instance, the predetermined WAP site furnished by server 131 is bookmarked for quick access thereto. CLEAR key 211 is used for deleting entries. BACK key 223 is used for returning to the previous WAP page. In addition for entering numerals, the keys on keypad 237 may also be used to enter text in a well known manner when telephone 200 is put in a text entry mode. For example, in the text entry mode, pressing key “2” once causes an entry of a letter “A;” twice an entry of a letter “B;” and thrice an entry of a letter “C.”FIG. 3 illustrates the schematics of WAP enabled wireless telephone 200. As shown in FIG. 3, telephone 200 includes, among others, processor 305 which is connected to telephone circuitry 309 for telephone communications; memory 311 containing WAP microbrowser 320, data for display such as the menu data, an operating system, etc.; operating portion 313 includes circuitry for connecting processor 305 to different keys described above for carrying out their respective functions; modem facility 325 including a modem or network card for modulating (demodulating) signals containing communication information for transmission (reception); and transceiver 329 for transmitting and receiving signals to and from a wireless network. Through display driver 327, processor 305 provides formatted data for display on display 329 having screen 203.

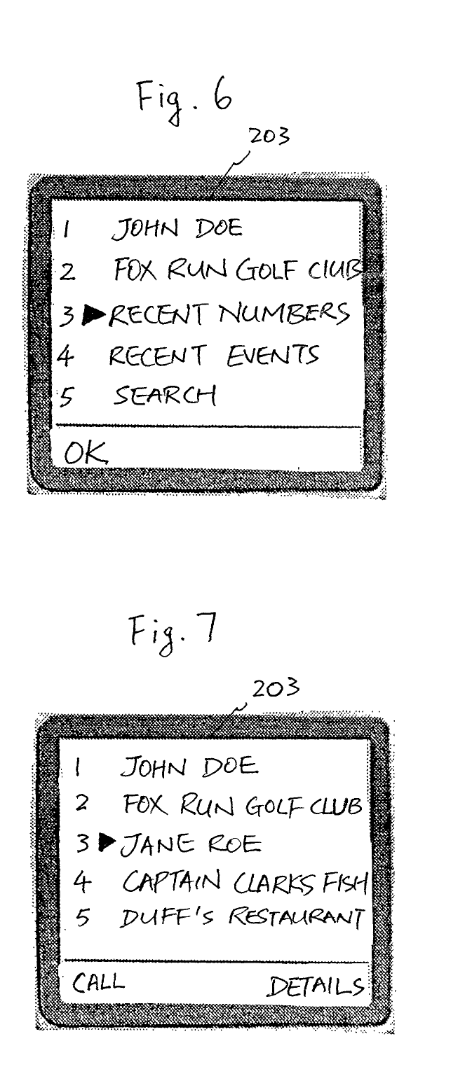

Referring to FIG. 4, the user may utilize telephone 200 to initiate a request for accessing a WAP information service through microbrowser 320 by selecting the URL of the WAP site furnished by server 131. The request, including the URL and a device ID identifying telephone 200, is transmitted using modem facility 325 and transceiver 329 to WAP gateway 407 through wireless network 405. As is well known, WAP gateway 407, serving as an interface between wireless network 405 and Internet 409, provides the necessary protocol translation (e.g., between WAP and transmission control protocol/Internet protocol (TCP/IP)) and optimization, security, activity tracking and administration. Data communicated between telephone 200 and WAP gateway 407 are in accordance with a WAP datagram protocol (WDP). Based on the received URL, a hypertext transfer protocol (HTTP) interface (not shown) in gateway 407 retrieves a Login WAP page from the corresponding WAP site on Internet 409. The retrieved WAP page is converted into a compressed data format for transmission over wireless network 405 to telephone 200 based on its device ID included in the transmission. Microbrowser 320 in telephone 200 interprets the compressed data and displays on screen 203 the Login WAP page.

At the Login page, the user is prompted to enter a telephone number identifying the user, which in this instance is the telephone number of WAP enabled wireless telephone 200, also known as a “mobile directory number (MDN).” Upon entry of the user telephone number, server 131 in response returns another WAP page, prompting the user to enter a password to verify his/her authorization to access the WAP information service in question.

It should be noted at this point that the user telephone number and password were earlier furnished to system 100 when the user registered with the WAP information service. Such a registration may be realized by calling an operator in system 100, by accessing a registration page at the predetermined WAP site or otherwise. Of course, in lieu of or in addition to use of a password for verifying the user's access authorization, other security measures may be employed which include, e.g., use of a PIN, the maiden name of the user's mother, biometric information concerning the user, etc.

After the password is verified by server 131 in a conventional manner, server 131 retrieves from user database 136 the user file identified by the received user telephone number. It should be noted at this point that the user file contains, in addition to previously requested information from system 100, configuration information which may be provided by the user during the registration and modified subsequently based on the user's preferences. Relying on such configuration information, server 131 personalizes organization of WAP content shown on screen 203, in accordance with the user's preferences.

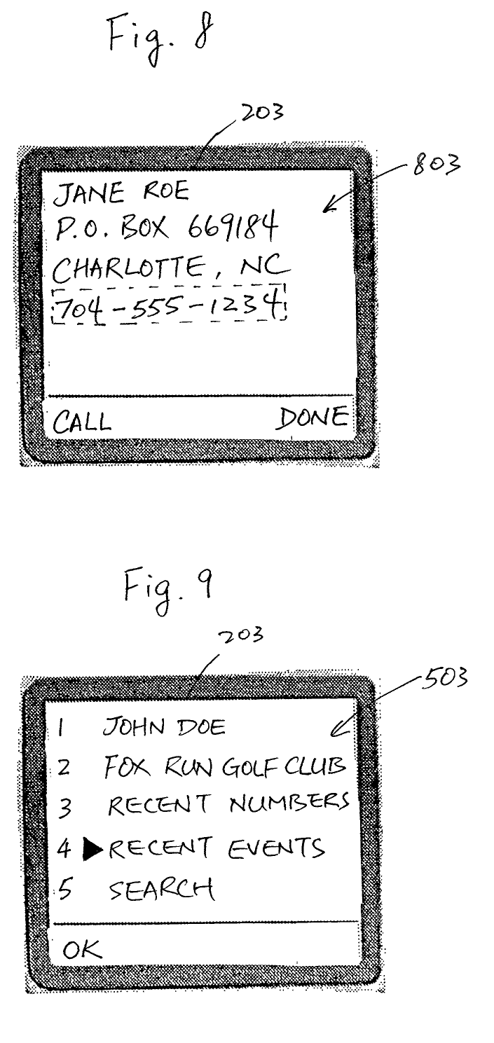

Thus, for example, based on the information in the user file, server 131 provides on screen 203 a Menu WAP page, denoted 503 in FIG. 5. As shown in FIG. 5, WAP page 503 is populated with five selectable options, namely, “1 John Doe,” “2 Fox Run Golf Club,” “3 Recent Numbers,” “4 Recent Events,” and “5 Search.”

In this instance, the information offered by these selectable options originate from system 100 responding to 41698.1028 previous information assistance calls by the user. For example, in one such call, the user requested from an operator the listing of John Doe. The operator searched database server 126 and obtained the requested listing, including the telephone number and address of John Doe. In a conventional manner, the operator then provides the listing information to the user and/or offers to connect the user to John Doe's number. In addition, in accordance with the invention, the operator caused the John Doe listing information to be stored in database 136 in an appropriate format and, in particular, in the user file identified by the user telephone number. In another information assistance call, the user requested from an operator a listing of the Fox Run Golf Club. Similarly, the operator searched database server 126 and obtained the requested listing information. The operator also caused the listing information to be incorporated in the user file, in accordance with the invention.

At Menu WAP page 503, the user may utilize navigation keys 205 to direct cursor 505 to select one of the aforementioned options. In this instance, option 1 corresponds to the listing of John Doe which the user most recently requested from system 100, and option 2 corresponds to the listing of the Fox Run Golf Club which the user requested after the John Doe listing. When the user selects either option 1 or 2, a “Call” action is displayed, which is associated with key 209a. By way of example, let's say the user selects option 2, and presses key 209a to perform the Call action. In response, processor 305 causes telephone circuitry 309 to call the telephone number of the Fox Run Golf Club. This telephone number is linked to option 2 and provided by microbrowser 320. The actual telephone number may be revealed on screen 203 when it is being called.

Option “3 Recent Numbers” corresponds to a directory of recently requested listings, obtained from the information assistance service. Referring to FIG. 6, the action associated with key 209a is changed to “OK” in response to a selection of option 3. By pressing key 209a in this instance, the user accesses the directory containing a configurable number of listings. Referring to FIG. 7, the instant directory contains the listings of “1 John Doe,” “2 Fox Run Golf Club,” “3 Jane Roe,” “4 Captain Clarks Fish,” and “5 Duff's Restaurant”, and other listings which can be scrolled up or down using navigation key 205. The listings are organized in chronological order with the most recently requested listing (e.g., John Doe's) appearing first. As also shown in FIG. 7, an action “Details” associated with key 209b is displayed on screen 203. In this instance, the user selects listing 3 and presses key 209b to access the details of the listing. In response, server 131 returns WAP page 803 in FIG. 8, which provides the details of the listing of Jane Roe including her telephone number and address. Her telephone number in this instance is highlighted on page 803, and linked to the “Call” action associated with key 209a. If key 209a is pressed at this point, processor 305 causes telephone circuitry 309 to call the highlighted telephone number to reach Jane Doe.

FIG. 9 illustrates Menu WAP page 503 when option “4 Recent Events” is selected. By pressing key 209a associated with the “OK” action, data concerning the events about which the user recently inquired is presented. FIG. 10 illustrates WAP page 1003 enumerating the event listings, limited by a pre-configured number thereof, in chronological order of their inquiries with the latest inquired event listed first. If the pre-configured number of events overflow screen 203, the user may use navigation key 205 to scroll up or down the list to view the complete list. The user may also use key 205 to shift the page content from left to right, and vice versa, to view the complete page content. By way of example, the user in this instance selects event listing 5 concerning the play “Macbeth.” In addition, the user presses key 209a associated with a “Details” action.

In response, server 131 provides WAP page 1103 in FIG. 11, presenting the details of the event listing which include the date, show time, title and venue of the Macbeth play, its address, etc. A Directions option, denoted 1105 is also shown on page 1103, which may be selected by placing the cursor at the option. Pressing key 209a associated with a Call action in this instance enables the user to obtain travel directions to the venue.

In a first illustrative embodiment, when the call action is selected, processor 305 is programed to call an information assistance service, e.g., by system 100. Specifically, after system 100 receives the call, the travel directions are provided to the user through an operator and/or IVR unit 134. A technique for providing directions in this manner, for example, is disclosed in commonly assigned copending U.S. application Ser. No. 09/826,122 filed on Apr. 4, 2001, which is hereby incorporated by reference. In accordance with the disclosed technique, directions are provided to the user in installments. Through a connection between telephone 200 and system 100, the travel directions are read by IVR unit 134 to the user in an automated voice or by the operator verbally, whose amount is controllable by the user. To that end, the travel directions are stored in a data file provided by directions server 145, and an indicator is used which is associated with the data file. The travel directions are delivered to the user from the file in a selected order, e.g., sequentially. When the user requests to halt the delivery of the directions by pressing a predetermined key on telephone 200 as the user may be able to memorize only a limited number of directions at a time, server 145 or the operator accordingly stops the delivery, thereby conveying a first installment of directions to the user. The indicator is then used to indicate where the first installment ends in the data file. When the user requests a second installment of directions through a re-connection to system 100, by relying on the indicator, server 145 or the operator locates in the data file the proper beginning direction of the second installment, and delivers the second installment to the user. This process can be repeated until all of the directions in the file are communicated to the user.

To effectively provide travel directions using information system 100, in accordance with an aspect of the invention the address of the desired destination, e.g., address 1109 on page 1103, is automatically delivered to system 100 when the directions call action is selected. At such time, microbrowser 320 generates a token including the telephone number of telephone 200 for identifying the source of the token, and data concerning address 1109. The token, thus generated, is transmitted to WAP server 131 before the aforementioned call is made to system 100. When switch 114 in system 100 receives the call from telephone 200, switch 114 receives call set-up signals containing an ANI, which includes the telephone number of telephone 200. IVR unit 134 or an operator accesses directions server 145 when a request for travel directions is ascertained in the beginning of the call. Directions server 145 then receives the telephone number of telephone 200 from computer 128 which is derived from the call set-up signals. In addition, directions server 145 retrieves from WAP server 131 the token identified by such a telephone number, which was previously transmitted thereto. Directions server 145 extracts from the identified token address 1109 as the destination address for which the travel directions are sought.

In accordance with another aspect of the invention, information concerning the location of telephone 200 may also be included in the aforementioned token. For example, such location information may be provided by a GPS receiver, which may be incorporated in telephone 200. Alternatively, it may be provided by other well known mobile handset location techniques including, e.g., a wireless network based triangulation technique. In any event, when the directions call is received, directions server 145 also derives the location of telephone 200 from the location information in the token. Server 145 assumes that the telephone location is the origination location from where the user will proceed to the destination address unless the user indicates otherwise to IVR unit 134 or an operator during the call. Directions server 145 then accesses the aforementioned map server on the Internet to obtain the requested directions from the origination location to the destination address. The directions are provided to the user through IVR unit 134 or an operator in the manner described before.

In a second illustrative embodiment, the selection of the directions call action on page 1103 causes microbrowser 320 to issue a request through Internet 409 to the map server directly. The request includes the data concerning destination address 1109. Similarly, the request may also include an origination location, which may be manually input by the user using keypad 237 while telephone 200 is put in a text mode, or automatically provided by a GPS receiver in telephone 200 or otherwise. With such destination address and origination location information, the map server returns to telephone 200 a WAP page containing the requested directions. However, in the event that the request does not include an origination location, the map server returns to telephone 200 a WAP page containing an area map centered at the destination address 1109.

In this instance, page 1103 also provides thereon “Reservation and Info” option 1121. It should be noted that this option appears when attendance at the event is limited by availability and thus advance reservation for the event is preferred. Otherwise, a simple “Info” option may be provided, instead. Thus, the appearance of option 1121 serves an additional purpose of informing the user of the limited availability, and prompting the user to make reservation if the user is interested in attending the particular event. If the user in this instance selects “Reservation and Info” option 1121, and presses key 209a associated with a “Call” action, processor 305 causes telephone circuitry 309 to connect telephone 200 to the appropriate telephone number designated for the event in question. Through the established telephone connection, the user may then make the necessary reservation or purchase tickets for, and/or obtain further information about, the event.

In an alternative embodiment, the selection of option 1121, followed by pressing key 209a associated with a “Call” action, results in generating by microbrowser 320 a token containing the telephone number of telephone 200 for identifying the source of the token, and data concerning the event which includes those shown on page 1103. This token, destined for WAP server 131, is transmitted through Internet 409 to which server 131 is connected. After the transmission of the token, processor 305 causes telephone circuitry 309 to call information system 100.

It is well understood that system 100 receives and responds to requests for information assistance, and provides an enhanced directory assistance service incorporating, e.g., a StarBack® service feature disclosed in U.S. Pat. No. 5,797,092, and other service features disclosed in commonly assigned copending U.S. application Ser. No. 09/447,465 filed on Nov. 22, 1999, which is hereby incorporated by reference. System 100 also provides personalized services disclosed, e.g., in commonly assigned copending U.S. application Ser. No. 09/865,230 filed on May 25, 2001, which is hereby incorporated by reference. In addition, system 100 in this instance is capable of providing concierge-type services, e.g., ordering and purchasing products and services, making reservations, etc. for a user. When switch 114 in system 100 receives the above call from telephone 200, switch 114 receives call setup signals containing an ANI of telephone 200. After an operator in system 100 answers the call and ascertains the user's request for making reservation for an event, the operator at terminal 120 causes any token identified by the telephone number of telephone 200 to be retrieved from WAP server 131. The identifying telephone number is supplied by computer 128 which derives the telephone number from the received ANI. When the identified token is opened on terminal 120, the operator is presented with the data concerning the subject event enclosed in the token, including those data on page 1103. In possession of such event data, the operator is ready to help the user to make reservation for the event. To that end, the operator may ask the user for the number of people attending the event, his/her preferences such as seat arrangements, price ranges, etc. In another embodiment, system 100 has access to a database for event reservations, containing real-time information concerning an inventory of vacancies for an event. In that embodiment, the operator may make the reservation for the user in real time and confirms the user's reservation in the same call. Otherwise, the user's reservation may be confirmed in a later communication, such as a WAP message to telephone 200.

In the event that the user wants to learn more information about the event which is not readily available to the operator, the operator may offer to connect the user's call to the appropriate telephone number for obtaining such information. After the call is connected to the appropriate number, and the user obtains the necessary information about the event, the user may be reconnected to information system 100 for further assistance by pressing, e.g., a “*” key on telephone 200, without first terminating the call, in accordance with the aforementioned StarBack® service feature. An operator answering the re-connected call, who may be different from the earlier operator, again can retrieve the event data enclosed in the token previously received in server 131, thereby further assisting the user with the reservation, or providing other concierge-type services or information directory assistance.

Returning briefly to Menu WAP page 503 in FIG. 5, if the user selects and enters option “5 Search” on that page, server 131 returns WAP page 1203 in FIG. 12 to telephone 200. As shown in FIG. 12, page 1203 enumerates multiple options to search a collection of recent events in the user file for a desired event. These search options include, e.g., an option to search by venue, option to search by city, option to search by keyword, and option to search by date. For example, when the option to search by venue is exercised, the user may be prompted for entry of a zip or area code associated with the venue. Based on the user's entry, the user may be prompted for additional entry of the name of the venue, which requires the user to enter at least the first few letters of the venue name. Alternatively, a list of all venues associated with the entered zip or area code is presented, from which the user selects the desired venue. In any event, when the desired venue is selected, a list of events associated with the desired venue, which may be arranged in chronological order of the event date, is presented for the user's convenience. A desired event can then be selected from the list and the details of the desired event may be provided on a WAP page similar to WAP page 1103 described before.

When the option to search by city is exercised, the user may be prompted to enter the name of the city where the event takes place. After ascertaining the desired city name, server 131 returns a list of events associated with the desired city, which may be arranged in chronological order of the event date. A desired event can then be selected from the list and the details of the desired event may be provided on a WAP page similar to WAP page 1103 described before.

When the option to search by keyword is exercised, the user is prompted for a keyword describing the desired event. After entering the keyword, the user may further be prompted for the name of the city where the desired event takes place to narrow the search. In response, server 131 returns a list of the events satisfying the search criteria, which may be arranged in chronological order of the event date. The desired event can then be selected from the list and the details of the desired event may be provided on a WAP page similar to WAP page 1103 described before.

When the option to search by date is exercised, the user is prompted to enter the date of the desired event. The date entry may be facilitated by providing the user with a list of dates to choose from, which may be specified in the number of days relative to today's date, e.g., “Today,” “Today+1,” “Today+2,”, “Today+3,” etc. After entering the desired date, the user may further be prompted for the name of the city where the desired event takes place to narrow the search. After entering the name of the desired city, the user may further be prompted for a keyword describing the desired event to further narrow the search. The title of the desired event satisfying the search criteria is then provided, and the details of the desired event may also be provided on a WAP page similar to WAP page 1103 described before.

### Advanced Information Assistance Services

The invention also takes advantage of use of an advanced wireless facility, e.g., the 3G wireless network, which supports simultaneous data and voice communications with an end user, to provide inventive information assistance services. In an illustrative embodiment of the invention, the user utilizes telephone 200 to make an information assistance call by dialing such typical access digits as “411,” “*555,” “555-1212,” “00,” “1-800-555-1212,” etc. Such a call is received by system 100 at T1 interface of telephone switch 114 via an inbound voice channel. In receiving the call, system 100 also receives the user's ANI and other information in the call set-up signals. After the call is answered by an operator, the user typically states his/her information assistance request by identifying, as far as he/she is able, the destination party he/she wishes to contact. As mentioned before, the operator searches databases of information stored on database server 126 for the appropriate destination telephone number. Database records meeting the user's request may be displayed on operator terminal 120. The operator retrieves the information most closely matching the caller's request.

The operator may then initiate an outgoing call for the user by seizing an outgoing voice channel from T1 span 112 and outdialing the destination telephone number. Outdialing is a function of switch 114, whereby switch 114 transmits the destination telephone number after it is entered. Switch host computer 128 is notified of the outgoing call and automatically instructs switch 114 to apply a CPA therein to the outbound channel and a DTMF receiver to the inbound channel after outdialing. Such a CPA is sensitive to, and capable of identifying, telephone connection status conditions and signals including ring tone, busy, reorder, PBX intercept, SIT intercept, vacant code, reorder-SIT, no circuit LEC, reorder-carrier, no circuit-carrier, dial tone, continuous on tone, and silence. Switch 114 afterwards connects the user on the inbound channel to the outgoing call on the outbound channel.

The CPA monitors the outgoing call on the outbound channel for a predetermined number of rings, a predetermined amount of time, or until a specified connection status is detected. A successful call, in which the destination telephone is answered, is recognized by switch 114. Illustratively, switch 114 identifies a successful call by detecting, on the outbound channel, the bit transition that occurs when the destination telephone converts from an on-hook status to an off-hook status. The detection of a successful call is relayed to switch host computer 128 by switch 114.

When an outgoing call is successfully completed, system 100 remains passively connected to the call. When the destination telephone is disconnected, switch 114 detects another bit transition indicating that the destination telephone changed from off-hook to on-hook. In response, switch 114 removes the application of the CPA on the outbound channel.

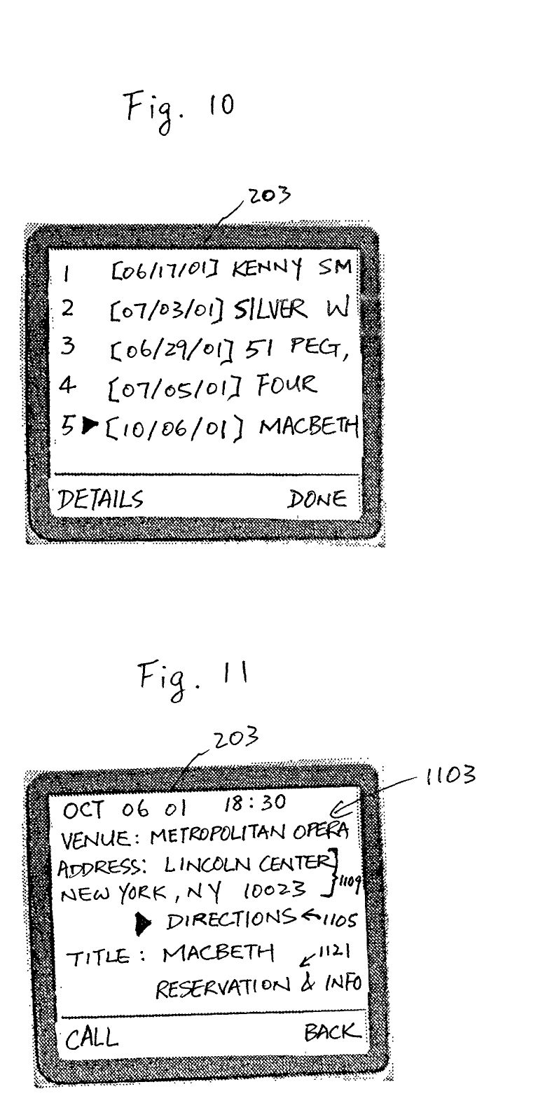

If the user disconnects, whether before or after the called party disconnects, the user's call is broken down and the connection between the user and system 100 is terminated. If the user does not disconnect from system 100 within a configurable period of time after the called party disconnects, WAP server 131 transmits an information assistance menu to telephone 200 in accordance with the invention. To that end, the device ID of telephone 200 is also included in the user file identified by the user telephone number. Thus, in accordance with the invention, WAP server 131 retrieves from user database 136 such a user file based on the user telephone number derived from the received ANI, as indicated at step 1303 in FIG. 13. WAP server 131 at step 1306 looks up the device ID of telephone 200 in the retrieved user file. At step 1309, server 131 generates a WAP page including the information assistance menu in WML for transmission. Server 131 at step 1312 transmits (or pushes) the WAP page to telephone 200 identified by the device ID just looked up through Internet 409 and wireless network 405, e.g., a 3G wireless network.

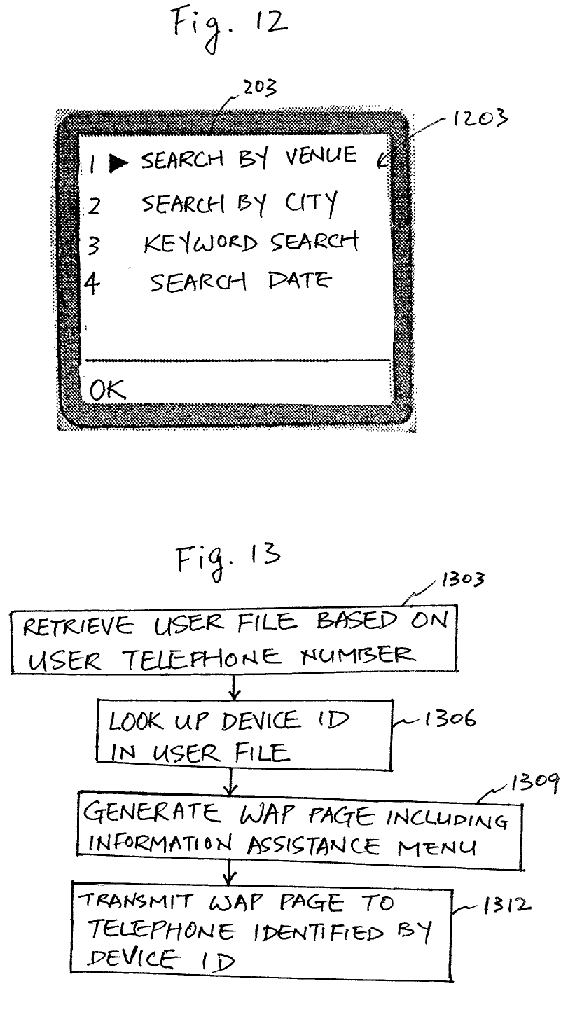

After telephone 200 receives the aforementioned WAP page from server 131, the received page is opened by microbrowser 320, which is denoted 1403 in FIG. 14. As shown in FIG. 14, page 1403 contains the information assistance menu including options selectable by pressing specified keys on telephone 200. Alternatively, the user's selection is spoken into telephone 200, which is received and recognized by a voice recognition device in switch 114. In this instance, pressing the “#” key enables the user to hear from telephone 200 a recitation of the destination telephone number provided by voice server 130 through the already established voice connection with system 100; pressing the “*” key enabled the user to be re-connected to an operator, in accordance with the aforementioned StarBack® service feature; and pressing the “7” key enables the user to have the destination number transmitted by WAP server 131 to telephone 200 for display on screen 203, and linked to a Call action, to facilitate retrying the destination number in the future at the user's convenience. Switch 114 relies on a DTMF detector to detect any key depression by the user, which triggers computer 128 to perform the corresponding task, with the help of other components in system 100.

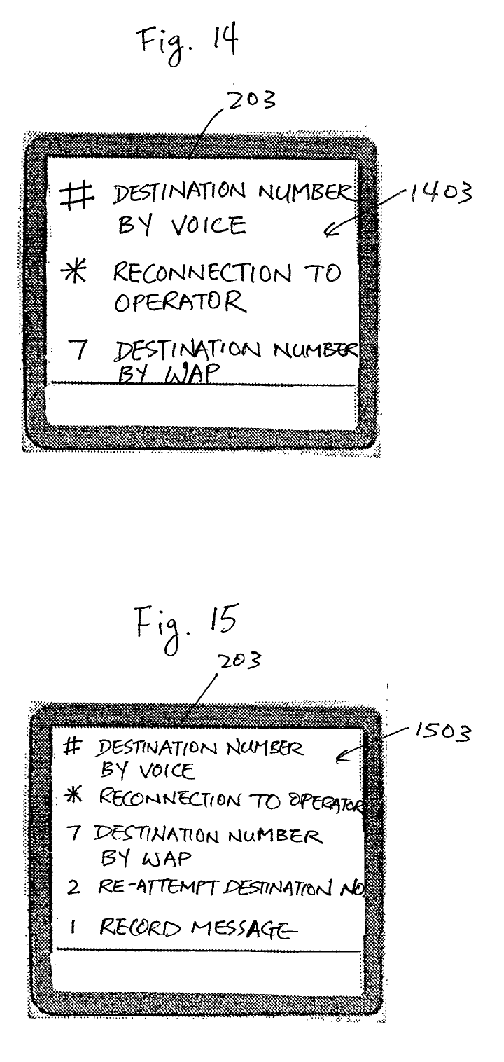

Otherwise, if the aforementioned outgoing call cannot be successfully completed, e.g., the call status condition of the outgoing call identified by the CPA as a busy signal, switch 114 terminates the outgoing call by releasing the outbound channel, with the inbound channel intact. In accordance with the invention, WAP server 131 then generates a WAP page including a second information assistance menu, and transmits the same to telephone 200. This WAP page, denoted 1503 in FIG. 15, contains options similar to those on page 1403 described above. However, page 1503 in this instance includes two additional options, namely, an option to have switch 114 attempt the same destination telephone number again by pressing the “2” key, and another option to record a message for later delivery to the destination party by pressing the “1” key on telephone 200. A technique for recording and delivering such a message is disclosed, e.g., in the commonly assigned copending U.S. application Ser. No. 09/918,867 filed on Jul. 31, 2001, hereby incorporated by reference.

WAP page 1503 may also be provided to telephone 200 in the event that the call status condition of the outgoing call is detected by the CPA in switch 114 as a ring-no-answer condition. Under that condition, it is desirable to allow sufficient time for the destination party to answer the call, but yet also provide the user with WAP page 1503 including the second Information assistance menu described above, other than simply waiting continuously for an answer. At the same time, the ring tone on the outbound channel may be temporarily muted or its volume is temporarily reduced. In addition, voice server 130 may vocally inform, through the inbound voice channel, the user of the available options shown on screen 203 while he/she is waiting. If the caller chooses to do nothing and wait, the ring tone continues until the destination telephone is answered, or the user disconnects.

In the event that the call status condition of the outgoing call is identified as a network communication failure, e.g., reorder, PBX intercept, SIT intercept, vacant code, reorder-SIT, no circuit LEC, reorder-carrier, no circuit-carrier, dial tone, continuous on tone, or silence, WAP server 131 generates and transmits to telephone 200 a WAP message indicating the network communication failure. In addition, the user's already established voice connection with system 100 is transferred to an operator and/or voice server 130 for further assistance.

The foregoing merely illustrates the principles of the invention. It will thus be appreciated that those skilled in the art will be able to devise numerous other arrangements which embody the principles of the invention and are thus within its spirit and scope.

For example, information system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing an information service to a user comprising:
receiving from the user a request through a first medium;
searching a database for information responsive to the request;
organizing the information at a data location; and
allowing access by the user to the data location to obtain therefrom at least part of the information through a second medium.

2. The method of claim 1 wherein the first medium includes a voice medium.

3. The method of claim 1 wherein the second medium includes a data medium.

4. The method of claim 1 wherein the data location is identified by a uniform resource locator (URL).

5. The method of claim 1 wherein the data location includes a WAP site.

6. The method of claim 1 wherein the information includes a telephone number desired by the user.

7. The method of claim 1 wherein the information concerns an event.

8. The method of claim 1 wherein the information includes an address.

9. The method of claim 1 wherein the information is organized according to a preference of the user.

10. The method of claim 1 wherein the at least part of the information is obtained as a result of a search by the user.

11. The method of claim 10 wherein the search is based on a location.

12. The method of claim 10 wherein the search is based on a keyword.

13. The method of claim 10 wherein the search is based on a date.

14. A method for providing a service to a user of a communications device, comprising:
receiving a request through a first medium afforded by the communications device;
obtaining information responsive to the request;
providing the user with access to the information;
receiving a message generated by the communications device based on at least part of the information, the message being received through a second medium afforded by the communications device; and
providing the service based on content of the received message.

15. The method of claim 14 wherein the message includes a telephone number associated with the communications device.

16. The method of claim 14 wherein the message includes an address.

17. The method of claim 14 wherein the message includes event information.

18. The method of claim 14 wherein the service includes making reservation for the user.

19. The method of claim 14 wherein the service includes providing travel directions to the user.

20. The method of claim 14 wherein the first medium includes a voice medium.

21. The method of claim 14 wherein the second medium includes a data medium.

22. The method of claim 14 wherein the information is accessible at a data location.

23. The method of claim 22 wherein the data location is identified by a URL.

24. The method of claim 22 wherein the data location includes a WAP site.

25. A method for providing a service to a user of a communications device, comprising:
receiving a request from the communications device;
searching a database for information responsive to the request, the information including a desired telephone number;
connecting the communications device to a station associated with the desired telephone number through a voice connection;
identifying a status condition of the voice connection; and
providing data through a data connection to the communications device in response to the status condition.

26. The method of claim 25 wherein the data indicates the status condition.

27. The method of claim 25 wherein the data concerns at least one service option.

28. The method of claim 27 wherein the at least one service option includes an option to obtain the desired telephone number.

29. The method of claim 27 wherein the at least one service option includes an option to connect the user to an operator of the service.

30. The method of claim 27 wherein the at least one service option includes an option to leave a message for delivery to a party associated with the desired telephone number.

31. The method of claim 25 wherein the voice connection includes a telephone connection, and the status condition includes a ring-no-answer condition.

32. The method of claim 25 wherein the voice connection includes a telephone connection, and the status condition includes a busy condition.

33. The method of claim 25 wherein the voice connection includes a telephone connection, and the status condition includes a communication failure.

34. A method for use in a communications apparatus capable of communications in a plurality of media, the method comprising:
transmitting a request through a first medium;
accessing information responsive to the request through a second medium;
generating a message based on at least part of the information; and
transmitting the message to a system which provides a service based on content of the message.

35. The method of claim 34 wherein the message includes a telephone number associated with the communications apparatus.

36. The method of claim 34 wherein the message includes an address.

37. The method of claim 34 wherein the message includes event information.

38. The method of claim 34 wherein the service includes making reservation for a user of the communications apparatus.

39. The method of claim 34 wherein the service includes providing travel directions to a user of the communications apparatus.

40. The method of claim 34 wherein the first medium includes a voice medium.

41. The method of claim 34 wherein the second medium includes a data medium.

42. A system for providing an information service to a user comprising:
an interface for receiving from the user a request through a first medium;
a device for searching a database for information responsive to the request; and
a server for organizing the information at a data location, thereby allowing access by the user to the data location to obtain therefrom at least part of the information through a second medium.

43. The system of claim 42 wherein the first medium includes a voice medium.

44. The system of claim 42 wherein the second medium includes a data medium.

45. The system of claim 42 wherein the data location is identified by a URL.

46. The system of claim 42 wherein the data location includes a WAP site.

47. The system of claim 42 wherein the information includes a telephone number desired by the user.

48. The system of claim 42 wherein the information concerns an event.

49. The system of claim 42 wherein the information includes an address.

50. The system of claim 42 wherein the information is organized according to a preference of the user.

51. The system of claim 42 wherein the at least part of the information is obtained as a result of a search by the user.

52. The system of claim 51 wherein the search is based on a location.

53. The system of claim 51 wherein the search is based on a keyword.

54. The system of claim 51 wherein the search is based on a date.

55. A system for providing a service to a user of a communications apparatus, comprising:
an interface for receiving a request through a first medium afforded by the communications device;
a device for obtaining information responsive to the request, the user being provided with access to the information; and
a server for receiving a message generated by the communications apparatus based on at least part of the information, the message being received through a second medium afforded by the communications apparatus, the service being provided based on content of the received message.

56. The system of claim 55 wherein the message includes a telephone number associated with the communications device.

57. The system of claim 55 wherein the message includes an address.

58. The system of claim 55 wherein the message includes event information.

59. The system of claim 55 wherein the service includes making reservation for the user.

60. The system of claim 55 wherein the service includes providing travel directions to the user.

61. The system of claim 55 wherein the first medium includes a voice medium.

62. The system of claim 55 wherein the second medium includes a data medium.

63. The system of claim 55 wherein the information is accessible at a data location.

64. The system of claim 63 wherein the data location is identified by a URL.

65. The system of claim 63 wherein the data location includes a WAP site.

66. A system for providing a service to a user of a communications apparatus, comprising:
an interface for receiving a request from the communications device;
a device for searching a database for information responsive to the request, the information including a desired telephone number;
a switch for connecting the communications device to a station associated with the desired telephone number through a voice connection;
a processor for identifying a status condition of the voice connection; and
a server for providing data through a data connection to the communications device in response to the status condition.

67. The system of claim 66 wherein the data indicates the status condition.

68. The system of claim 66 wherein the data concerns at least one service option.

69. The system of claim 68 wherein the at least one service option includes an option to obtain the desired telephone number.

70. The system of claim 68 wherein the at least one service option includes an option to connect the user to an operator of the service.

71. The system of claim 68 wherein the at least one service option includes an option to leave a message for delivery to a party associated with the desired telephone number.

72. The system of claim 66 wherein the voice connection includes a telephone connection, and the status condition includes a ring-no-answer condition.

73. The system of claim 66 wherein the voice connection includes a telephone connection, and the status condition includes a busy condition.

74. The system of claim 66 wherein the voice connection includes a telephone connection, and the status condition includes a communication failure.

75. Apparatus capable of communications in a plurality of media, the apparatus comprising:
a first interface for transmitting a request through a first medium;
a second interface for accessing information responsive to the request through a second medium;
a processor for generating a message based on at least part of the information; and
a transmitter for transmitting the message to a system which provides a service based on content of the message.

76. The apparatus of claim 75 wherein the message includes a telephone number associated with the communications apparatus.

77. The apparatus of claim 75 wherein the message includes an address.

78. The apparatus of claim 75 wherein the message includes event information.

79. The apparatus of claim 75 wherein the service includes making reservation for a user of the apparatus.

80. The apparatus of claim 75 wherein the service includes providing travel directions to a user of the apparatus.

81. The apparatus of claim 75 wherein the first medium includes a voice medium.

82. The apparatus of claim 75 wherein the second medium includes a data medium.

83. The apparatus of claim 75 wherein the first interface includes telephone circuitry.

84. The apparatus of claim 75 wherein the second interface includes a modem facility.

85. The apparatus of claim 75 comprising a WAP enabled mobile device.
